(19) United States
(12) Patent Application Publication
(10) Pub. No.: US 2016/0108324 A1
(43) Pub. Date: Apr. 21, 2016

(54) METHOD AND SYSTEM FOR PREPARING A PIPELINEABLE HYDROCARBON MIXTURE

(71) Applicant: STATOIL CANADA LIMITED, Calgary (CA)

(72) Inventors: Einar Eng JOHNSEN, Trondheim (NO); Knut Vebjørn GRANDE, Trondheim (NO); Anne HOFF, Trondheim (NO); Marianne HAUGAN, Trondheim (NO); Harald VINDSPOLL, Trondheim (NO)

(73) Assignee: STATOIL CANADA LIMITED, Calgary, AB (CA)

(21) Appl. No.: 14/890,038

(22) PCT Filed: May 8, 2014
(86) PCT No.: PCT/EP2014/059500

§ 371 Date: Nov. 9, 2015

(30) Foreign Application Priority Data
May 10, 2013 (CA) 2816133
May 10, 2013 (GB) 1308406.6

(51) Int. Cl. C10G 9/00; C10G 55/04; F17D 1/14; B01J 19/24

(52) U.S. Cl. CPC C10G 9/007; B01J 19/24; C10G 55/04; F17D 1/14

(57) ABSTRACT

The present invention provides a method for preparing a pipelineable hydrocarbon mixture from a crude heavy hydrocarbon mixture comprising: —visbreaking said crude heavy hydrocarbon mixture at a temperature of 350 to 440° C. and a pressure of 20 to 150 bar for 0.5 to 15 minutes to produce a visbroken hydrocarbon mixture; and —mixing said visbroken hydrocarbon mixture with a diluent to produce said pipelineable hydrocarbon mixture.

The present invention relates to a method for preparing a pipelineable hydrocarbon mixture from a crude heavy hydrocarbon mixture comprising visbreaking. The invention also relates to a method of transporting a heavy hydrocarbon mixture recovered from a wellsite to a refinery and to a heavy hydrocarbon recovery method. Additionally the invention relates to the pipelineable hydrocarbon mixture and visbroken hydrocarbon mixture obtained in the methods.

### BACKGROUND

Heavy hydrocarbons, e.g. bitumen, represent a huge natural source of the world's total potential reserves of oil. Present estimates place the quantity of heavy hydrocarbon reserves at several trillion barrels, more than 5 times the known amount of the conventional, i.e. non-heavy, hydrocarbon reserves. This is partly because heavy hydrocarbons are generally difficult to recover by conventional recovery processes and thus have not been exploited to the same extent as non-heavy hydrocarbons. Heavy hydrocarbons possess very high viscosities and low API (America) Petroleum Institute) gravities which makes them difficult, if not impossible, to pump in their native state. This makes heavy hydrocarbon mixtures challenging to transport from wells to refineries. Pumping of high viscosity fluids is also expensive. Generally therefore the flowability of heavy hydrocarbon mixtures obtained from heavy hydrocarbon reservoirs needs to be improved through partial or full upgrading before transportation by pipeline to a conventional refinery.

The transportability of viscous heavy hydrocarbon mixtures is conventionally improved by dilution with a lighter hydrocarbon such as naphtha, a very light crude oil or a condensate. The dilution of the heavy hydrocarbon with the diluent typically reduces its overall API to about 20 degrees enabling it to be pumped to a refinery. Vast amounts of diluent are, however, required. For example 20-40% by weight of the pumpable hydrocarbon mixture may be diluent.

There are numerous disadvantages to the use of a diluent in this way. These include:

The need to transport diluent on-site. This problem becomes particularly acute for off-shore well sites.

The need to identify a compatible diluent for each heavy hydrocarbon mixture, e.g. one that does not cause precipitation of asphaltenes

The need to separate the diluent and the hydrocarbon mixture at the refinery prior to processing

Down stream processing/cleaning of the diluent prior to its reuse or disposal. Often it is preferable to return it to the well site (i.e. to recycle it) although this again requires it to be pumped a significant distance.

Another approach that has previously been adopted is to upgrade heavy hydrocarbon mixtures on site prior to transportation to a refinery. Thus a heavy hydrocarbon mixture recovered from a well may be upgraded to form lighter oil having an API of about 20-35 degrees on site and then pumped to a refinery. CA 1,314,260 and CA 2,195,165, for example, both disclose processes wherein heavy hydrocarbon is upgraded by visbreaking to produce a pipelineable product.

CA 1,314,260 discloses a process wherein heavy crude oil is thermally processed by visbreaking and the resulting product is deasphalted to afford syncrude. The thermal visbreaking step is described as being more severe than conventional visbreaking processes that have been used in refineries on atmospheric residues. Thus the visbreaking is carried out at a temperature of 426 to 510° C. for a time that produces a certain level of severity in the visbroken product. Typical pressures and residence times given for the visbreaking are 2 to 30 bar and 0.5 to 50 minutes respectively. The severity of the visbreaking conditions can be tolerated in the process because coke and other insoluble materials formed in the thermal reaction under severe conditions is removed, along with asphaltenes, in a subsequent deasphalting step. The deasphalting step substantially reduces the viscosity of the visbroken product and reduces the content of metal and sulphur in the product. Following deaspalting, the deasphalting solvent is preferably removed from the upgraded hydrocarbon by supercritical separation.

CA 2,195,165 describes a similar process for converting heavy crude oils and bitumen to a stable product suitable for pipeline transportation. Like the method in CA 1,314,260, the method involves visbreaking in severe conditions. More specifically in the method of CA 2,195,165 a heavy crude oil is preferably preflashed to produce heavy and light fractions and then the heavy fraction is fed to a severe visbreaker wherein a conversion exceeding 7.5% by weight is carried out. CA 2,195,165 teaches that it is advantageous to maximise visbreaking in order to produce a lower viscosity product and a maximum amount of lighter products. No specific temperatures, pressures or residence times are disclosed in CA 2,195,165.

CA 2,796,146 also discloses a process for reducing the viscosity of heavy crude oils at the well head or oil centre to improve their transportability based on visbreaking. The process of CA 2,796,146 involves reducing the viscosity of heavy crude oils, in situ, at the well head by visbreaking, wherein the energy required for the visbreaking is obtained by means of a solar concentration plant. The preferred conditions for visbreaking in the process of CA 2,796,146 are a temperature of 350 to 400° C. and a pressure of 5 to 50 bar for 20 minutes to 2.5 hours. In the examples of CA 2,796,146 the viscosity of the heavy crude oils is improved by about 90%, specifically by 95, 96, 88 and 93% in each of examples 1 to 4 respectively. This level of viscosity improvement requires a high level of conversion in the visbreaking process. The mechanism of capturing solar heat depends on the visbreaking reaction conditions. If the reaction temperature is higher than 380° C., the fluid used as heating fluid for the visbreaker is preferably a molten salt which is heated by a solar field. If the reaction temperature is lower than 380° C., a diathermic oil may alternatively be used. The focus of CA 2,796,146 is very much on the use of solar energy to power the visbreaking process.

Alternatively, a recovered heavy hydrocarbon mixture may be partially refined or upgraded on-site, e.g. using a processing plant located close to the production well. CA 2,530,148, for example, discloses a process wherein part of a bitumen feed is upgraded and used to convert the overall feed into a pipeline-transportable crude oil. The process involves the following steps:

1. Separation of a bitumen feed into two parts, a first part and a second part.

2. Separation of the first part into light and heavy fractions, preferably by distillation.

3. Thermally cracking, e.g. by visbreaker soaking, the heavy fraction into a second light fraction and a residual fraction and fractionating said fractions.

4. Mixing the second part and the two light fractions to form a transportable hydrocarbon.

5. Using the residual fraction from thermal cracking for energy generation.

The process of CA 2,530,148 is therefore relatively complex involving several energy intensive steps, e.g. distillation, thermal cracking and fractionation. This is undesirable, especially in a relatively remote location, e.g. offshore. Moreover a residual fraction of the bitumen feed is not incorporated into the pipeline-transportable crude oil and thus represents a loss in process yield.

CA 2,773,000 also describes a process wherein heavy oil having an API gravity of 20 or less is partially upgraded at the well site in order to improve its pumpability. In the method taught in CA 2,773,000 the heavy oil is thermally cracked in a process referred to as high conversion soaker cracking. In this process the heavy oil is thermally cracked at a pressure of 0 to 1 bar and at a temperature of 370 to 440° C. for 15 to 150 minutes in a soaker drum whilst at the same time injecting stripping steam into the drum to separate thermally cracked oil. In preferred methods of CA 2,773,000 the stripping steam comprising the thermally cracked oil is separated into different fractions. The heavier fraction of the thermally cracked oil is discharged from the separator and used as fuel to produce steam for recovering further heavy oil from the reservoir. Thus like CA 2,530,148 a residual fraction of the bitumen feed is not incorporated into the pipeline-transportable crude oil and thus represents a loss in process yield.

A need therefore exists for alternative processes for treating crude heavy hydrocarbon mixtures to improve their transportability by pipeline. Simple and economically attractive processes that utilise the whole spectrum of hydrocarbons recovered are clearly desirable.

### SUMMARY OF INVENTION

Viewed from a first aspect the present invention provides a method for preparing a pipelineable hydrocarbon mixture from a crude heavy hydrocarbon mixture comprising:

visbreaking said crude heavy hydrocarbon mixture at a temperature of 350 to 440° C. and a pressure of 20 to 150 bar for 0.5 to 15 minutes to produce a visbroken hydrocarbon mixture; and

mixing said visbroken hydrocarbon mixture with a diluent to produce said pipelineable hydrocarbon mixture.

Viewed from a further aspect, the present invention provides A method of transporting a heavy hydrocarbon mixture recovered from a wellsite to a refinery comprising:

preparing a pipelineable hydrocarbon mixture from a crude heavy hydrocarbon mixture by a method as hereinbefore defined at said wellsite; and

pumping said pipelineable hydrocarbon mixture to said refinery.

Viewed from a further aspect, the present invention provides a heavy hydrocarbon recovery process comprising:

extracting a heavy hydrocarbon and water mixture from a subterranean formation;

adding a diluent to said heavy hydrocarbon and water mixture;

separating a crude heavy hydrocarbon mixture from said heavy hydrocarbon and water mixture in a separator;

visbreaking said crude heavy hydrocarbon mixture as hereinbefore defined to produce a visbroken hydrocarbon mixture;

mixing said visbroken hydrocarbon mixture with a diluent to produce a pipelineable hydrocarbon mixture; and

pumping said pipelineable hydrocarbon mixture to a refinery.

Viewed from a further aspect, the present invention provides a system for preparing a pipelineable hydrocarbon mixture from a crude heavy hydrocarbon mixture comprising:

a separator for separating a heavy hydrocarbon and water mixture into a crude heavy hydrocarbon mixture and water, wherein said separator has an inlet for heavy hydrocarbon and water mixture, an outlet for water and an outlet for crude heavy hydrocarbon mixture;

a visbreaker for visbreaking said crude heavy hydrocarbon mixture having an inlet for crude heavy hydrocarbon mixture fluidly connected to crude heavy hydrocarbon outlet of said separator and an outlet for visbroken hydrocarbon mixture;

a cooling means for cooling said visbroken hydrocarbon mixture having an inlet for visbroken hydrocarbon mixture fluidly connected to the visbroken hydrocarbon mixture outlet of said visbreaker and an outlet for cooled visbroken hydrocarbon mixture; and

a means for adding diluent to said cooled visbroken hydrocarbon mixture to produce said pipelineable hydrocarbon mixture.

Viewed from a further aspect, the present invention provides a pipelineable hydrocarbon mixture obtainable by the method as hereinbefore defined.

Viewed from a further aspect, the present invention provides a pipelineable hydrocarbon mixture obtained by the method as hereinbefore defined.

Viewed from a further aspect, the present invention provides a visbroken hydrocarbon mixture obtainable by visbreaking a crude heavy hydrocarbon mixture at a temperature of 350 to 440° C. and a pressure of 20 to 150 bar for 0.5 to 15 minutes.

Viewed from a further aspect, the present invention provides a visbroken hydrocarbon mixture obtained by visbreaking a crude heavy hydrocarbon mixture at a temperature of 350 to 440° C. and a pressure of 20 to 150 bar for 0.5 to 15 minutes.

Viewed from a further aspect, the present invention provides a visbroken hydrocarbon mixture having an API gravity of 12 to 22°, a viscosity of 50 to 2000 cSt at 15° C., and an olefin content of less than 3.0%.

### DEFINITIONS

As used herein the term “pipelineable hydrocarbon mixture” refers to a hydrocarbon mixture that meets a pipeline specification.

As used herein the term “hydrocarbon mixture” refers to a combination of different hydrocarbons, i.e. to a combination of various types of molecules that contain carbon atoms and, in many cases, attached hydrogen atoms. A “hydrocarbon mixture” may comprise a large number of different molecules having a wide range of molecular weights. Generally at least 90% by weight of the hydrocarbon mixture consists of carbon and hydrogen atoms. Up to 10% by weight may be present as sulfur, nitrogen and oxygen as well as metals such as iron, nickel and vanadium (i.e. as measured sulfur, nitrogen, oxygen or metals).

As used herein the term “heavy hydrocarbon mixture” refers to a hydrocarbon mixture comprising a greater proportion of hydrocarbons having a higher molecular weight than a relatively lighter hydrocarbon mixture. Terms such as “light”, “lighter”, “heavier” etc. are to be interpreted herein relative to “heavy”.

As used herein the term “visbreaking” refers to a process wherein a hydrocarbon mixture is heated to reduce its viscosity by cracking of heavy or heavier hydrocarbons into lighter hydrocarbons.

As used herein the term “visbreaking conversion” refers to the net conversion of heavy hydrocarbons in the feedstock having a boiling point of greater than 525° C. that are converted to hydrocarbons having a boiling point of less than 525° C. in the visbreaking process. Visbreaking conversion (%) is 100×((quantity of 525° C.+ in feedstock minus quantity of 525° C.+ in visbroken product)/quantity of 525° C.+ in feedstock). The quantity of hydrocarbon that has a boiling point above 525° C. in a hydrcarbon mixture can be determined by plotting its distillation curve.

As used herein the term “upgrading” refers to a process wherein the hydrocarbon mixture is altered to have more desirable properties, e.g. to providing lighter, synthetic crude oils from heavy hydrocarbon mixtures by chemical processes including visbreaking.

As used herein “kerosene” refers to a hydrocarbon fraction having a boiling point between about 180° C. and 240° C.;

As used herein “light gas oil” refers to a hydrocarbon fraction having a boiling point between about 240° C. and 320° C.;

As used herein “heavy gas oil” refers to a hydrocarbon fraction having a boiling point between 320° C. and 375° C.

As used herein “vacuum gas oil” refers to a hydrocarbon fraction having a boiling point between about 375° C. and 525° C.;

As used herein “vacuum residue” refers to a hydrocarbon fraction having a boiling point of greater than about 525° C. The vacuum residue comprises asphaltenes.

As used herein API gravity refers to API as measured according ASTM D287.

As used herein viscosity refers to viscosity in cSt at 15° C. as measured according to ASTM D445 method.

As used herein % wt olefins refers to olefin content as measured by NMR according to CAPP (Canadian Association Petroleum Producers).

As used herein the term “fluidly connected” encompasses both direct and indirect fluid connections.

### DETAILED DESCRIPTION

The methods of the present invention are for preparing a pipelineable hydrocarbon mixture that preferably meets a pipeline specification. Pipeline specifications vary in different countries and different networks and are also varied on a seasonal basis. A typical pipeline specification, e.g. for the Enbridge pipeline system in Canada, is a viscosity of 350 cSt at the pipeline reference temperature, wherein the pipeline reference temperature is varied between 6-18° C. depending on the season and a density of less than 940 kg/I at 15° C.

The API and viscosity requirements of pipeline specifications ensure that the pipelineable hydrocarbon mixtures can be pumped efficiently from wellsites to refineries without destabilisation, e.g. precipitation, occurring. Preferred pipelineable hydrocarbon mixtures have an API gravity of at least 18° and more preferably at least 20°. Particularly preferred pipelineable hydrocarbon mixtures have an API gravity of 18 to 30°, more preferably 19 to 26° and still more preferably 20 to 24°. Preferably the viscosity of the pipelineable hydrocarbon mixture is in the range 100-500 cSt at the pipeline reference temperature, e.g. at 15° C., more preferably 300-350 cSt at the pipeline reference temperature, e.g. at 15° C., e.g. about 350 cSt at the pipeline reference temperature, e.g. at 15° C. To meet these requirements many crude heavy hydrocarbon mixtures must be processed to reduce their viscosity prior to transport in pipelines.

The method of the present invention is directed to the preparation of a pipelineable hydrocarbon mixture from a crude heavy hydrocarbon mixture. The crude heavy hydrocarbon mixture preferably has an API gravity of less than about 18°. More preferably the API gravity of the crude heavy hydrocarbon mixture is 10 to 18°, more preferably 12 to 18° and still more preferably 16 to 18°. The viscosity of the crude heavy hydrocarbon mixture is preferably 250 to 3000 cSt at 15° C., more preferably 400 to 2000 cSt at 15° C. and still more preferably 500 to 1500 cSt at 15° C.

In the method of the present invention the viscosity of the crude heavy hydrocarbon mixture is decreased for pipeline transportation by visbreaking at a temperature of 350 to 440° C. and a pressure of 20 to 150 bar for 0.5 to 15 minutes to produce a visbroken hydrocarbon mixture. The visbreaking conditions are much milder than those employed in conventional visbreaking processes and are specifically selected to ensure that an appropriate balance between viscosity reduction and visbroken hydrocarbon mixture stability is achieved. It is critical that the visbroken hydrocarbon mixture is both pumpeable and stable (e.g. does not form precipates). Stability is important since, unlike conventional visbreaking processes, in the method of the invention the entirety of the visbroken hydrocarbon mixture is preferably incorporated into the pipelineable hydrocarbon mixture. The thermal severity of the visbreaking process is therefore lower than in conventional processes.

In preferred methods of the invention visbreaking is at a temperature of 390 to 430° C., still more preferably 395 to 425° C. and yet more preferably 400 to 420° C. Still more preferably visbreaking is at a temperature of 390 to 415° C., still more preferably 395 to 410° C. and yet more preferably about 400° C. More preferably visbreaking is at a pressure of 50 to 150 bar, still more preferably 70 to 130 bar, yet more preferably 80 to 120 bar and especially preferably 90 to 110 bar. More preferably visbreaking is for 1 to 10 minutes, still more preferably 2 to 8 minutes, yet more preferably 3 to 7 minutes and especially preferably about 5 minutes.

The visbreaking process may be carried out in a conventional visbreaking apparatus. Preferably a coil visbreaker (sometimes referred to as a furnace visbreaker) or a soaker visbreaker is used. Preferably the visbreaking is a purely thermal process. Preferably therefore hydrogen is not present during visbreaking. Preferably a catalyst is not present during visbreaking.

In a coil visbreaker heating and cracking occurs in furnace tubes. The visbroken hydrocarbon mixture is generally quenched upon exiting the visbreaker to stop the cracking reactions. As described below in more detail, this is preferably achieved by heat exchange with the crude heavy hydrocarbon mixture being fed to the coil visbreaker. The extent of the cracking reaction is preferably controlled by regulation of the speed of flow of the crude heavy hydrocarbon mixture through the furnace tubes. Of course the temperature and/or pressure are also preferably controlled. The residence time in a coil visbreaker tends to be relatively short. Thus when visbreaking occurs in a coil visbreaker, visbreaking is preferably for 1 to 8 minutes, yet more preferably 2 to 6 minutes and especially preferably about 5 minutes. Preferably visbreaking is at a temperature of 395 to 425% and more preferably 410 to 420° C. Still more preferably visbreaking is at a temperature of 395 to 415° C.

A soaker visbreaker comprises a furnace and a soaker drum. The crude heavy hydrocarbon mixture enters the furnace and is heated to a specified temperature and is then transferred to a drum fluidly connected to the furnace. The bulk of the cracking reaction occurs in this drum wherein the heated crude heavy hydrocarbon mixture is held at an elevated temperature for a pre-determined period of time. As in a coil visbreaker, the visbroken hydrocarbon mixture is generally quenched upon exiting the visbreaker, specifically the drum, to stop the cracking reactions, preferably by heat exchange with the crude heavy hydrocarbon mixture being fed to the furnace of the soaker visbreaker. The extent of cracking reaction is preferably controlled by the residence time in the drum of the soaker visbreaker. The temperature and/or pressure are also preferably controlled. The residence time in a soaker visbreaker tends to be longer than in a coil visbreaker. Then when visbreaking occurs in a soaker visbreaker, visbreaking is preferably for 1 to 12 minutes, more preferably 5 to 10 minutes and especially preferably about 10 minutes. Preferably visbreaking is at a temperature of 390 to 410% and more preferably 400 to 405° C.

As mentioned above, the conditions employed in the visbreaking reaction are critical in the methods of the present invention. In a conventional visbreaking process the conversion is typically 15%. This is the maximum level of conversion that can be achieved without generation of problematic precipitates. In the method of the present invention the conversion level is preferably 1 to 14%, more preferably 5 to 12% and still more preferably 8 to 10%. These conversion levels are intentionally significantly lower than those used in conventional visbreaking processes. This reflects the fact that a less severe or milder cracking process is employed. This reduces the viscosity of the crude hydrocarbon mixture by a sufficient level to meet pipeline specifications whilst minimising the extent of unsaturated compounds in the visbroken hydrocarbon mixture thereby improving stability.

The visbreaking in the method of the invention upgrades the crude heavy hydrocarbon mixture. Thus the average molecular weight of the hydrocarbons present in the visbroken hydrocarbon mixture is lower than the average molecular weight of the hydrocarbons in the crude heavy hydrocarbon starting mixture. Advantageously the visbreaking may be carried out at the well site. This means that the crude heavy hydrocarbon mixture need only be transported a minimum distance.

In preferred methods of the present invention the crude heavy hydrocarbon mixture is preheated prior to visbreaking. Preferably the crude heavy hydrocarbon mixture is preheated to a temperature of 300 to 400° C., still more preferably 320 to 390° C. and yet more preferably 330 to 345° C. Preferably heating is at least partially carried out in a heat exchanger against the crude visbroken hydrocarbon mixture exiting the visbreaker.

In the methods of the present invention the crude heavy hydrocarbon mixture is optionally flashed prior to visbreaking. This removes the lightest fractions from the crude heavy hydrocarbon mixture. In preferred methods of the invention, however, the crude heavy hydrocarbon mixture is not flashed.

In further preferred methods of the present invention substantially all of the crude heavy hydrocarbon mixture is visbroken. Thus substantially all of the hydrocarbon in the crude heavy hydrocarbon mixture is visbroken. Thus in preferred methods of the invention the heavy hydrocarbon mixture is not separated into heavier and lighter fractions by, for example, distillation or fractionation, prior to visbreaking. In preferred methods at least 90% wt, still more preferably at least 95% wt and still more preferably about 100% wt of the crude heavy hydrocarbon mixture is visbroken. In particularly preferred methods of the invention the entirety of the crude heavy hydrocarbon mixture is visbroken. This is an advantage of the process of the present invention because the use of the entirety of heavy hydrocarbon in the visbreaking process generates a visbroken hydrocarbon mixture having a desirable hydrocarbon structure. In other words, the visbroken hydrocarbon mixture produced in the process of the present invention comprises a more balanced mixture of hydrocarbons than a product produced from upgrading a lighter fraction obtained from distillation.

Optionally the crude heavy hydrocarbon mixture undergoes treatment(s) to remove solids such as sands therefrom prior to visbreaking. Solids, such as sand, may be removed from a crude heavy hydrocarbon mixture by, e.g. hot water extraction, by filtration or by settling processes known in the art. The exact details of the cleaning process will depend on how the heavy hydrocarbon mixture has been recovered. The skilled man will readily be able to identify suitable cleaning techniques.

In further preferred methods of the present invention no solid additives are added to the crude heavy hydrocarbon mixture prior to or during said visbreaking. Particularly preferably no metallic oxides are added to the heavy hydrocarbon mixture prior to or during the visbreaking. Similarly the visbreaking process is preferably non-catalytic. This is advantageous since the crude heavy hydrocarbon mixture fed to the visbreaker comprises heavy metals that would be likely to foul catalysts.

Optionally a diluent is added to the crude hydrocarbon mixture prior to visbreaking. Preferred diluents are those described below in relation to the separation process.

In preferred methods of the present invention the crude heavy hydrocarbon mixture is separated from a heavy hydrocarbon and water mixture in a separator prior to visbreaking. Any conventional separator may be used. Representative examples of suitable separators are gravity separators or cyclone separators. Preferred methods of the invention therefore comprise:

separating the crude heavy hydrocarbon mixture from a heavy hydrocarbon and water mixture in a separator;

visbreaking the crude heavy hydrocarbon mixture as hereinbefore defined to produce a visbroken hydrocarbon mixture; and

mixing the visbroken hydrocarbon mixture with a diluent to produce the pipelineable hydrocarbon mixture.

In particularly preferred methods of the invention a diluent is added to the heavy hydrocarbon and water mixture prior to, or during, separation in the separator. Thus a particularly preferred method of the invention comprises:

adding a diluent to a heavy hydrocarbon and water mixture;

separating the crude heavy hydrocarbon mixture from the heavy hydrocarbon and water mixture in a separator;

visbreaking the crude heavy hydrocarbon mixture as hereinbefore defined to produce a visbroken hydrocarbon mixture; and

mixing the visbroken hydrocarbon mixture with a diluent to produce said pipelineable hydrocarbon mixture.

The purpose of the diluent is to improve the separation of the hydrocarbon and water phases in the separator. Preferably the diluent has an API of 20-80° and more preferably 30-70°. The diluent is preferably a hydrocarbon diluent. Representative examples of suitable diluents include naphtha, light crude oil or gas oils, synthetic oil, gas condensates and mixtures thereof. Preferred diluents are naphtha, gas condensates, synthetic oil and mixtures thereof. Diluent may, for example, comprise 0-100% wt naphtha, 0-70% wt light crude oil or gas oil, 0-25% gas condensates, 0-3% wt butane and 0-3% wt BTEX. When naphtha and/or gas condensate is used as the diluent it preferably has an API of 40 to 60°. When synthetic oil is used as the diluent it preferably has an API of 20 to 40°.

In preferred methods of the invention the amount of diluent added prior to or during separation is 5 to 40% wt and more preferably 10 to 35% wt based on the total weight of the resulting crude heavy hydrocarbon mixture. When the diluent is naptha and/or gas condensate, the amount added prior to or during separation is still more preferably 15 to 30% wt and yet more preferably 18 to 25% wt based on the total weight of the resulting crude heavy hydrocarbon mixture. When the diluent is synthetic oil, the amount added prior to or during separation is still more preferably 25 to 40% wt and yet more preferably 30 to 38% wt based on the total weight of the resulting crude heavy hydrocarbon mixture. Thus in the methods of the present invention the crude heavy hydrocarbon mixture that undergoes visbreaking preferably comprises 60 to 95% wt heavy hydrocarbon and 5 to 40% wt diluent and more preferably 65 to 90% wt heavy hydrocarbon and 10 to 35% wt diluent. Generally the majority of the diluent will survive the visbreaking process unchanged and will be present in the visbroken hydrocarbon mixture. The presence of the diluent in the visbreaking process has been found to be advantageous. Without wishing to be bound by theory, it is thought that the presence of the diluent in the visbreaking process leads to a more stable product by reducing the wall effect on the heavier hydrocarbons present in the heavy hydrocarbon mixture.

In some preferred methods of the present invention substantially all of the crude heavy hydrocarbon mixture separated from the heavy hydrocarbon and water mixture is visbroken. In such methods at least 90% wt, still more preferably at least 95% wt and still more preferably about 100% wt of the crude heavy hydrocarbon mixture separated from the heavy hydrocarbon and water mixture is visbroken. In particularly preferred methods of the invention the entirety of the crude heavy hydrocarbon mixture separated from the heavy hydrocarbon and water mixture is visbroken.

In other preferred methods of the present invention, only a fraction of the crude heavy hydrocarbon mixture separated from the heavy hydrocarbon and water mixture is broken. In such methods preferably 20 to 80% wt, still more preferably 30 to 70% wt and yet more preferably 40 to 60% wt of the crude heavy hydrocarbon mixture separated from the heavy hydrocarbon and water mixture is visbroken. Correspondingly in such methods preferably 20 to 80% wt, still more preferably 30 to 70% and yet more preferably 40 to 60% wt of the crude heavy hydrocarbon mixture separated from the heavy hydrocarbon and water mixture is not visbroken. As described below in more detail, this non-visbroken crude heavy hydrocarbon mixture is preferably blended with the visbroken hydrocarbon mixture.

In alternative methods, the crude heavy hydrocarbon mixture separated from water is fractionated or flashed to produce at least a lighter fraction and a heavier fraction prior to visbreaking. In this case, the heavier fraction then undergoes visbreaking. The lighter fraction is preferably mixed with the visbroken hydrocarbon mixture, along with diluent, to produce the pipelineable hydrocarbon mixture. Alternative methods of the invention therefore further comprise fractionating or flashing the crude heavy hydrocarbon mixture to produce a lighter fraction and a heavier fraction and visbreaking the heavier fraction.

Thus a particularly preferred method of the invention comprises:

adding a diluent to a heavy hydrocarbon and water mixture;

separating the crude heavy hydrocarbon mixture from the heavy hydrocarbon and water mixture in a separator;

fractionating or flashing the crude heavy hydrocarbon mixture to produce at least a lighter fraction and a heavier fraction

visbreaking the heavier fraction of crude heavy hydrocarbon mixture as hereinbefore defined to produce a visbroken hydrocarbon mixture; and

mixing the visbroken hydrocarbon mixture with a diluent and optionally the lighter fraction to produce said pipelineable hydrocarbon mixture.

In further preferred methods of the present invention no additives are added to the crude heavy hydrocarbon mixture following separation from water and prior to or during said visbreaking. Thus the visbreaking process is preferably non-catalytic. This is advantageous since the crude heavy hydrocarbon mixture fed to the visbreaker comprises heavy metals that would be likely to foul catalysts.

Preferred methods of the present invention further comprise recovering or extracting a heavy hydrocarbon and water mixture from a subterranean formation. Thus a preferred method of the present invention comprises:

extracting a heavy hydrocarbon and water mixture from a subterranean formation;

adding a diluent to the heavy hydrocarbon and water mixture;

separating the crude heavy hydrocarbon mixture from the heavy hydrocarbon and water mixture in a separator;

visbreaking the crude heavy hydrocarbon mixture as hereinbefore defined to produce a visbroken hydrocarbon mixture; and

mixing the visbroken hydrocarbon mixture with a diluent to produce said pipelineable hydrocarbon mixture.

The heavy hydrocarbon and water mixture may be extracted or recovered from a subterranean formation using any recovery technique but is preferably a thermal recovery technique. A preferred method of the present invention further comprises the step of recovering a heavy hydrocarbon and water mixture. Representative examples of some techniques that may be used to extract or recover heavy hydrocarbon mixture include water flooding, cyclic steam injection (CSS), vapour extraction (VAPEX), hot solvent injection and steam assisted gravity drainage (SAGD), as well as combinations of the afore-going. Preferably the extracting or recovering is by SAGD.

The API gravity of the heavy hydrocarbon, e.g. in the heavy hydrocarbon and water mixture extracted from a subterranean formation, is typically less than about 15°, preferably less than 12°, still more preferably less than 10°, e.g. less than 8°. Generally the API gravity of the heavy hydrocarbon extracted from a subterranean formation is about 5° to about 15°, more preferably from about 6° to about 12°, still more preferably about 7° to about 12°, e.g. about 7.5-9°. At such API gravities, viscosity and flowability are matters of concern. Examples of heavy hydrocarbon mixtures that typically have API gravities falling in the above-mentioned ranges are bitumens, tars, oil shales and oil sand deposits. Often heavy hydrocarbon mixtures are recovered at well sites located significant distances away from a refinery. For instance, the heavy hydrocarbon mixture may be recovered offshore. The improvement in viscosity that can be achieved in the method of the present invention is therefore critical.

As described above, a diluent is preferably added to the heavy hydrocarbon and water mixture prior to, or during, separation. Preferably this increases the API gravity of the crude heavy hydrocarbon mixture obtained from separation to 10 to 18°, more preferably 12 to 18° and still more preferably 16 to 18°. The viscosity of the crude heavy hydrocarbon mixture obtained from separation is preferably 250 to 3000 cSt at 15° C., more preferably 400 to 2000 cSt at 15° C. and still more preferably 500 to 1500 cSt at 15° C.

The API gravity of the visbroken hydrocarbon mixture is preferably 12 to 22°, more preferably 14 to 20° and still more preferably 17 to 19.5°. The viscosity of the visbroken hydrocarbon mixture is preferably 50 to 2000 cSt at 15° C., more preferably 100 to 1000 cSt at 15° C. and still more preferably 200 to 750 cSt at 15° C. The visbroken hydrocarbon mixture preferably comprises less than 3.0%, more preferably less than 1.0% and still more preferably less than 0.5% wt olefins. Particularly preferably the visbroken product comprises no detectable (i.e. <0.5 wt %) olefins.

In preferred methods of the invention the visbroken hydrocarbon mixture is cooled, preferably in a heat exchanger. As described above, the visbroken hydrocarbon mixture is preferably cooled against the crude heavy hydrocarbon mixture being fed into the visbreaker. Preferably the visbroken hydrocarbon mixture is cooled to a temperature of 20 to 80° C., more preferably 25 to 50° C. and still more preferably 25 to 30° C.

In a preferred method of the invention, the visbroken hydrocarbon mixture is stripped of gases, e.g. H₂S, after cooling. Thus in a preferred method the cooled visbroken hydrocarbon mixture is depressurised (e.g. by passing through a valve) and then flashed in a gas/liquid separator to produce gas and hydrocarbon mixture. The gas is preferably condensed and processed in a desulfurisation unit. The hydrocarbon mixture produced in the desulfurisation unit is preferably mixed with the visbroken hydrocarbon mixture obtained from the gas/liquid separator.

In preferred methods of the invention substantially all (e.g. the entirety) of the visbroken hydrocarbon mixture is incorporated into the pipelineable hydrocarbon mixture. Thus preferably at least 90% wt, more preferably at least 95% wt and still more preferably at least 99% wt of the visbroken hydrocarbon mixture is incorporated into the pipelineable hydrocarbon mixture. Preferably only gases produced during visbreaking are removed from the visbroken product. This is advantageous since it ensures that the visbroken product comprises a blend of hydrocarbons of a wide range of molecular weights. In particular heavier hydrocarbons are not removed, e.g. by deasphalting or fractionating. Thus in preferred methods of the invention the visbroken hydrocarbon mixture is not deasphalted. In further preferred methods of the invention the visbroken hydrocarbon mixture is not fractionated. In yet further preferred methods of the invention the visbroken hydrocarbon mixture is not hydrotreated. Preferably the visbroken hydrocarbon mixture is directly mixed with diluent to produce the pipelineable hydrocarbon mixture.

The visbreaking process employed in the present invention causes only a slight or subtle change in the overall composition of the heavy hydrocarbon mixture. Thus essentially the same spectrum or range of hydrocarbons of different molecular weights is present in the visbroken product as in the crude heavy hydrocarbon feedstock. The visbreaking process slightly reduces the quantity of some of the heavier hydrocarbons present. An advantage of the methods of the present invention is therefore that the visbroken hydrocarbon mixture has a desirable hydrocarbon structure for improving the transportability of the mixture. The visbroken hydrocarbon mixture preferably comprises a blend of hydrocarbons of a wide range of molecular weights. Particularly preferably the visbroken hydrocarbon mixture comprises kerosene, light gas oil and heavy gas oil. Particularly preferably the visbroken hydrocarbon mixture also comprises at least some asphaltenes.

Particularly preferably the visbroken hydrocarbon mixture produced in the method of the invention comprises a proportion of middle distillate, e.g. up to and including about 40% by weight of the mixture is kerosene, light gas oil and heavy gas oil. Preferably, the visbroken hydrocarbon mixture comprises at least 5% by weight, especially at least 10%, 15%, 20% or 30% by weight, of middle distillate. The upper limit on the amount of middle distillate present may be, e.g. 50% by weight.

Furthermore, in some embodiments the visbroken hydrocarbon mixture produced in the process of the invention preferably comprises a proportion of atmospheric residue, e.g. 1-45% by weight of the mixture is vacuum gas oil and vacuum residue. Preferably, the visbroken hydrocarbon mixture comprises less than 40% by weight of atmospheric residue, e.g. 5-35% by weight. The visbroken hydrocarbon mixture preferably comprises less than 15% by weight of vacuum residue, e.g. 1 to 10%, more preferably 1-5% by weight.

A preferred method of the present invention comprises:

visbreaking substantially all of the crude heavy hydrocarbon mixture at a temperature of 350 to 440% (e.g. 350 to 415° C.) and a pressure of 20 to 150 bar for 0.5 to 15 minutes to produce a visbroken hydrocarbon mixture; and

mixing the entirety of said visbroken hydrocarbon mixture with a diluent to produce said pipelineable hydrocarbon mixture.

A further preferred method of the present invention comprises:

separating said crude heavy hydrocarbon mixture from a heavy hydrocarbon and water mixture in a separator;

visbreaking said separated crude heavy hydrocarbon mixture at a temperature of 350 to 440° C. (e.g. 350 to 415° C.) and a pressure of 20 to 150 bar for 0.5 to 15 minutes to produce a visbroken hydrocarbon mixture; and

mixing the entirety of said visbroken hydrocarbon mixture with a diluent to produce said pipelineable hydrocarbon mixture.

Still more preferably the method further comprises pumping the visbroken hydrocarbon mixture to a refinery. In the methods of the present invention, the visbroken hydrocarbon mixture is mixed with a diluent to produce the pipelineable hydrocarbon mixture. The mixing of the visbroken hydrocarbon mixture and the diluent may be carried out using conventional equipment. The mixing or blending may, for example, be achieved by stirring or agitation in a vessel, using jet mixers or mixer nozzles, line mixing or pump mixing. Preferably the mixing step yields a homogenous product.

Preferably the diluent has an API of 20-80° and more preferably 30-70°. The diluent is preferably a hydrocarbon diluent. Representative examples of suitable diluents include naphtha, light crude oil or gas oils, synthetic oil, gas condensates and mixtures thereof. Preferred diluents are naphtha, gas condensates, synthetic oil and mixtures thereof. Diluent may, for example, comprise 0-100% wt naphtha, 0-70% wt light crude oil or gas oil, 0-25% gas condensates, 0-3% wt butane and 0-3% wt BTEX. When naphtha and/or gas condensate is used as the diluent it preferably has an API of 40 to 60°. When synthetic oil is used as the diluent it preferably has an API of 20 to 40°. Preferably the diluent is the same diluent that is added to the heavy hydrocarbon and water mixture prior to, or during, separation.

Preferably the quantity of diluent added to the visbroken hydrocarbon mixture is 0.5 to 20% wt and more preferably 1 to 15% wt based on the total weight of said pipelineable hydrocarbon mixture. When the diluent is naphtha and/or gas condensates the amount of diluent added to the visbroken hydrocarbon mixture is still more preferably 2.5 to 7.5% wt and especially preferably 2.5 to 5% wt of based on the total weight of said pipelineable hydrocarbon mixture. When the diluent is synthetic oil the amount of diluent added to the visbroken hydrocarbon mixture is still more preferably 10 to 20% wt and especially preferably 12.5 to 17.5% wt of based on the total weight of said pipelineable hydrocarbon mixture.

As mentioned above, the majority of the diluent added to the crude heavy hydrocarbon mixture prior to or during separation survives the visbreaking process. The total amount of diluent present in the final pipelineable hydrocarbon mixture is therefore approximately the sum of the diluent added prior to or during separation and the diluent added to the visbroken hydrocarbon mixture. Preferably the total amount of diluent in the final pipelineable hydrocarbon mixture is 5.5 to 60% wt, more preferably 11 to 50% wt based on the total weight of the pipelineable hydrocarbon mixture. When the diluent used is naphtha and/or gas condensates, the total amount of diluent in the final pipelineable hydrocarbon mixture is preferably 17.5 to 37.5% wt, more preferably 20.5 to 30% wt, based on the total weight of the pipelineable hydrocarbon mixture. When the diluent used is synthetic oil, the total amount of diluent in the final pipelineable hydrocarbon mixture is preferably 35 to 60% wt and more preferably 42.5 to 55.5% wt based on the total weight of the pipelineable hydrocarbon mixture.

In some preferred methods of the invention the visbroken hydrocarbon mixture is mixed or blended with non-visbroken heavy hydrocarbon mixture to produce the pipelineable hydrocarbon mixture. The mixing of the visbroken hydrocarbon mixture and the non-visbroken heavy hydrocarbon mixture may be carried out using conventional equipment. The mixing or blending may, for example, be achieved by stirring or agitation in a vessel, using jet mixers or mixer nozzles, line mixing or pump mixing. Preferably the mixing step yields a homogenous product. The mixing or blending with non-visbroken heavy hydrocarbon mixture may be carried out before or after diluent addition but is preferably after diluent addition.

When the method additionally comprises mixing or blending the visbroken hydrocarbon mixture with non-visbroken crude heavy hydrocarbon mixture, the total amount of diluent may be yet further reduced. In this case the total amount of diluent in the final pipelineable hydrocarbon mixture is preferably 2.5 to 30% wt and more preferably 5.5 to 25% wt based on the total weight of the pipelineable hydrocarbon mixture. When the diluent used is naptha and/or gas condensates, the total amount of diluent in the final pipelineable hydrocarbon mixture is preferably 8.5 to 18.5% wt and more preferably 10.5 to 15% wt, based on the total weight of the pipelineable hydrocarbon mixture. When the diluent used is synthetic oil, the total amount of diluent in the final pipelineable hydrocarbon mixture is preferably 17.5 to 30% wt and more preferably 21.5 to 28% wt based on the total weight of the pipelineable hydrocarbon mixture.

A significant advantage of the methods of the present invention is that the amount of diluent added to produce the final pipelineable hydrocarbon mixture is relatively low. This means less diluent needs to be transported to the wellsite, less diluent needs to be removed from the hydrocarbon mixture at the refinery and less diluent needs to be cleaned.

The pipelineable hydrocarbon mixture produced by the method of the invention preferably has an API gravity of at least about 5 degrees higher than that of the heavy hydrocarbon mixture extracted from the formation, e.g. an API gravity of at least about 8, 12, 15 or 18 degrees higher. In a preferred embodiment, the pipelineable hydrocarbon mixture has an API gravity of greater than 20 degrees. Preferred pipelineable hydrocarbon products have an API gravity of about 19-25 degrees, more preferably about 20-24 degrees.

In preferred methods of the present invention the pipelineable hydrocarbon mixture produced has a viscosity of less than 500 cSt at pipeline reference temperature (e.g. 15° C.), more preferably less than 400 cSt at pipeline reference temperature (e.g. 15° C.), still more preferably less than 350 cSt at pipeline reference temperature (e.g. 15° C.). Preferably the viscosity of the pipelineable hydrocarbon mixture is in the range 100-500 cSt at pipeline reference temperature (e.g. 15° C.), more preferably 300-350 cST at pipeline reference temperature (e.g. 15° C.), e.g. about 350 cSt at pipeline reference temperature (e.g. 15° C.). The pipelineable hydrocarbon mixture preferably comprises less than 1.5%, more preferably less than 0.5% and still more preferably less than 0.25% wt olefins. Particularly preferably the pipelineable hydrocarbon mixture comprises no detectable olefins.

A significant advantage of the methods of the present invention is that the equipment required to carry out the method is all conventional. Thus the separator, visbreaker, heat exchanger and means for adding diluent are all commercially available. Operators are also familiar with the operation and maintenance of such equipment.

The present invention also relates to a system for carrying out the method of the present invention, i.e. for preparing a pipelineable hydrocarbon mixture from a crude heavy hydrocarbon mixture. The system comprises:

a separator for separating a heavy hydrocarbon and water mixture into a crude heavy hydrocarbon mixture and water, wherein said separator has an inlet for heavy hydrocarbon and water mixture, an outlet for water and an outlet for crude heavy hydrocarbon mixture;

a visbreaker for visbreaking said crude heavy hydrocarbon mixture having an inlet for crude heavy hydrocarbon mixture fluidly connected to crude heavy hydrocarbon outlet of said separator and an outlet for visbroken hydrocarbon mixture;

a cooling means for cooling said visbroken hydrocarbon mixture having an inlet for visbroken hydrocarbon mixture fluidly connected to the visbroken hydrocarbon mixture outlet of said visbreaker and an outlet for cooled visbroken hydrocarbon mixture; and

a means for adding diluent to said cooled visbroken hydrocarbon mixture to produce said pipelineable hydrocarbon mixture.

In some preferred systems the visbreaker is a coil visbreaker. In other preferred systems the visbreaker is a soaker visbreaker.

A preferred system of the invention further comprises a means for adding diluent to the heavy hydrocarbon and water mixture either prior to, and/or in, said separator. The means may be, for example, a valve, nozzle or spray device.

Further preferred systems of the invention further comprise a heating means in between the separator and the visbreaker having an inlet for crude heavy hydrocarbon mixture fluidly connected to the crude heavy hydrocarbon mixture outlet of the separator and an oulet for heated crude heavy hydrocarbon mixture fluidly connected to the inlet for crude heavy hydrocarbon of said visbreaker. Preferably the heating means is a heat exchanger.

In further preferred systems of the present invention the cooling means is a heat exchanger. Preferably the cooling means also comprises a means for stripping gases from the visbroken hydrocarbon mixture.

Preferably the means for stripping gases comprises a valve, a flash drum, a condenser and a desulfurisation unit. Preferably the inlet of the valve is fluidly connected to the outlet for cooled visbroken hydrocarbon mixture of the cooling means and has an outlet for depressurised cooled visbroken hydrocarbon mixture. Preferably the inlet of the flash drum is fluidly connected to the outlet for depressurised cooled visbroken hydrocarbon mixture of the valve. Preferably the flash drum further comprises an outlet for gas and an outlet for cooled visbroken hydrocarbon mixture. Preferably the inlet of the condenser is fluidly connected to the outlet for gas of the flash drum. Preferably the condenser has an outlet for condensate. Preferably the inlet of the desulfurisation unit is fluidly connected to the outlet for condensate of the condenser. Preferably the desulfurisation unit comprises an outlet for H₂S, an outlet for sour water, an outlet for gas and an outlet for hydrocarbon liquid. Preferably the outlet for hydrocarbon liquid is fluidly connected to the outlet for cooled visbroken hydrocarbon mixture of the flash drum.

Further preferred systems of the invention further comprise a well arrangement for extracting the heavy hydrocarbon and water mixture from a subterranean formation, wherein the well arrangement is fluidly connected to the inlet for heavy hydrocarbon and water mixture of the separator. Particularly preferably the well arrangement comprises at least one SAGD well pair.

A particularly preferred system of the invention comprises:

a well arrangement for extracting the heavy hydrocarbon and water mixture from a subterranean formation;

a means for adding diluent to the heavy hydrocarbon and water mixture either prior to, and/or in, the separator;

a separator for separating a heavy hydrocarbon and water mixture into a crude heavy hydrocarbon mixture and water, wherein the separator has an inlet for heavy hydrocarbon and water mixture fluidly connected to said well arrangement, an outlet for water and an outlet for crude heavy hydrocarbon mixture;

a heating means for heating the crude heavy hydrocarbon mixture having an inlet for crude heavy hydrocarbon mixture fluidly connected to the crude heavy hydrocarbon mixture outlet of the separator and an oulet for heated crude heavy hydrocarbon mixture;

a visbreaker for visbreaking the crude heavy hydrocarbon mixture having an inlet for crude heavy hydrocarbon mixture fluidly connected the heated crude heavy hydrocarbon mixture outlet of the heating means and an outlet for visbroken hydrocarbon mixture;

a cooling means for cooling said visbroken hydrocarbon mixture having an inlet for visbroken hydrocarbon mixture fluidly connected to the visbroken hydrocarbon mixture outlet of the visbreaker and an outlet for cooled visbroken hydrocarbon mixture; and

a means for adding diluent to the cooled visbroken hydrocarbon mixture to produce the pipelineable hydrocarbon mixture.

Pipelineable hydrocarbon mixtures obtainable by, or obtained by, the methods hereinbefore described form further aspects of the invention.

Visbroken hydrocarbon mixtures obtainable by, or obtained by, visbreaking a crude heavy hydrocarbon mixture at a temperature of 350 to 440% and a pressure of 20 to 150 bar for 0.5 to 15 minutes form further aspects of the invention. A preferred visbroken hydrocarbon mixture has the following properties:

an API gravity of 12 to 22°, more preferably 14 to 20° and still more preferably 17 to 19.5°;

a viscosity of 50 to 2000 cSt at 15° C., more preferably 100 to 1000 cSt at 15° C. and still more preferably 150 to 750 cSt at 15° C.; and

an olefin content of less than 3.0%, more preferably less than 1.0% and still more preferably less than 0.5% wt olefins.

### DESCRIPTION OF THE FIGURES

FIG. 1 is a schematic of a preferred method and system of the present invention; and

FIG. 2 is a schematic of the experimental set up used in the examples hereinafter described.

### DETAILED DESCRIPTION OF THE FIGURES

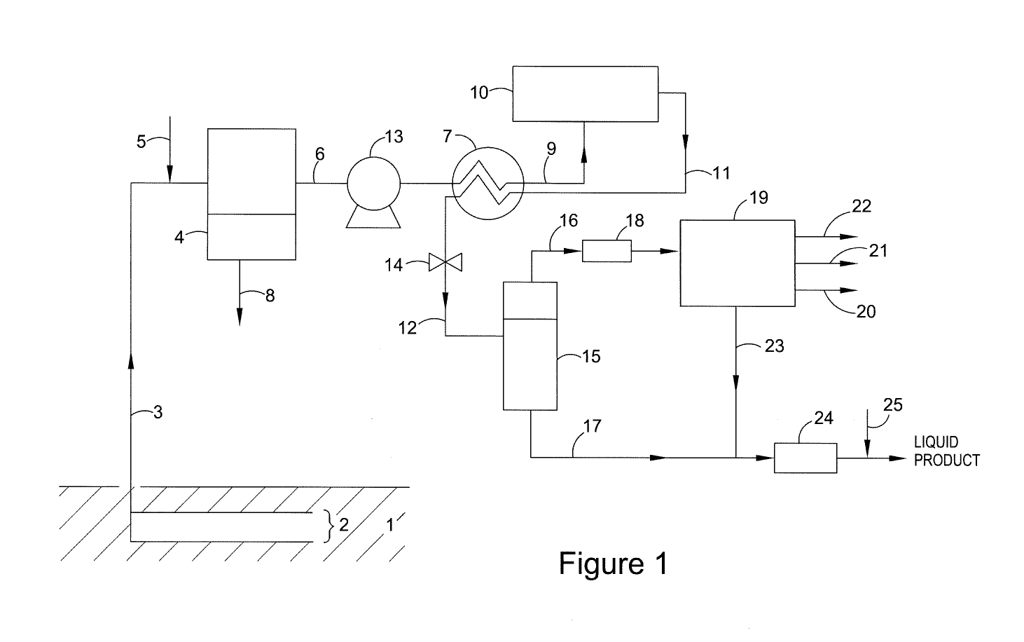

Referring to FIG. 1, a heavy hydrocarbon and water mixture is extracted and recovered from a formation 1 via a SAGD well arrangement 2. The heavy hydrocarbon and water mixture is pumped via line 3 to separator 4. A diluent 5 is added to the heavy hydrocarbon and water mixture during its transportation to the separator 4. The separator is a gravity separator. In the separator water and hydrocarbon phases are allowed to separate and this process is enhanced by the diluent. Once separation is completed the crude heavy hydrocarbon mixture (and the diluent) is transported via line 6 to a heat exchanger 7. A pump 13 is present in line 6 to increase the pressure of the crude heavy hydrocarbon mixture. The water phase is removed from the separator via line 8 and is transported to a water treatment facility.

In heat exchanger 7 the crude heavy hydrocarbon mixture is heated using visbroken hydrocarbon mixture exiting the visbreaker 10. The crude heavy hydrocarbon mixture is heated to at least 350° C. in the heat exchanger. After heating in the heat exchanger 7 the heated crude heavy hydrocarbon mixture is transported via line 9 to visbreaker 10. It may be a coil visbreaker or a soaker visbreaker. In the visbreaker the crude heavy hydrocarbon mixture is visbroken at 350 to 440° C. (e.g. 390 to 415° C.) and a pressure of 20 to 150 bar for 0.5 to 15 minutes. The visbroken hydrocarbon mixture is transported via line 11 to heat exchanger 7 wherein the visbroken hydrocarbon mixture is cooled. The cooled visbroken hydrocarbon mixture passes through a valve 14 in line 12 to a gas/liquid separator 15. Typically gas/liquid separator 15 is a flash drum. Gas produced in separator 15 is removed via line 16 and transported to condenser 18 and then to desulfurisation unit 19. In unit 19 H₂S, sour water and gas are removed via lines 20, 21 and 22 respectively. The condensate 23 comprising hydrocarbon mixture is combined with the bottoms of the gas/liquid separator in line 17 and transported to a cooler 24. After further cooling, diluent is added via line 25 to yield a pipelineable hydrocarbon mixture.

The advantages of the method of the present invention include:
Improvement of heavy hydrocarbon viscosity and a reduction in the total amount of diluent required
Low olefin content in the pipelineable hydrocarbon mixture
No hydrogenation
Low capex/opex
No volume loss of bitumen
Installation at wellsite
Less pipeline transportation volume
Stable pipelineable product with similar range of hydrocarbons of differing molecular weight, albeit in slightly modified proportions, as that present in the crude heavy hydrocarbon

### Examples

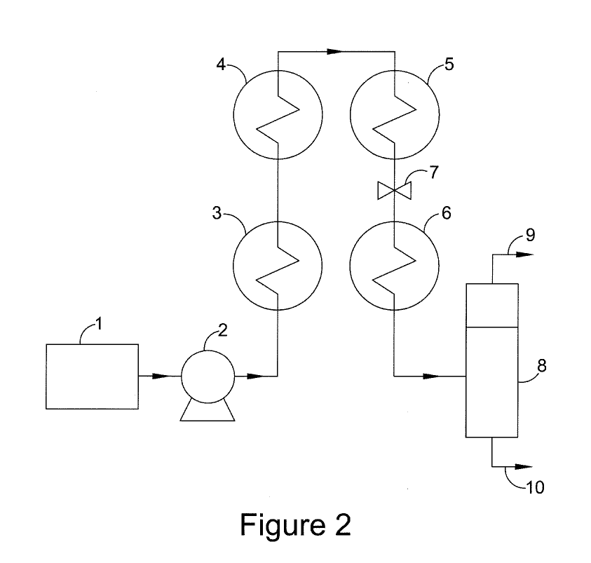

The experiments were carried out with partly diluted heavy oil from an oil producing field in Canada. The experimental set up is shown in FIG. 2. A pump (2) was used to bring the oil sample from a feed tank (1) to the first heater (3) with a typical flow of 10 liters per hour. The pressure downstream of the pump was typically around 10000 kPa. The first heater (3) brought the oil up to about 390° C. Some thermal conversion took place in the first heater (3). The second heater (4) heated the hydrocarbon mixture further to the maximum temperature which was reached at the exit of the said heater. The hydrocarbons flowed further through a pipe (about 35 ml) into a cooler (5). Assuming that thermal conversion of the hydrocarbon mixture takes place at temperatures above 380° C., the volume in which the thermal conversion took place was about 1 litre. The temperature was brought down to 60° C. through the first cooler (5). The second cooler (6) reduced the temperature further to 15° C. The pressure was reduced to atmospheric pressure through three choke valves in series (7) between the first and the second cooler. Downstream of the second cooler (6) the hydrocarbon mixture flowed into a gas/liquid separator (8) from which the gas (9) exited through the top and the liquid (10) through the bottom. Both gas and liquid were sampled and sent to various analyses and tests.

The experiments described here were all performed with a hydrocarbon liquid mixture with kinematic viscosity at 15° C. of 832 cSt, a gravity of 18.0° API and an olefin content of about 0.3 wt-%. The results are summarised in the table below.

Experimental Case 1:

The oil was treated at a maximum temperature of 390° C. (mean of 388° C. in the thermal conversion temperature range (>380° C.)) and a pressure of 9500 kPa. The residence time in the thermal conversion temperature range was about 4.6 minutes. The kinematic viscosity at 15° C. of the liquid was reduced with 43% to 472 cSt, the gravity was increased with 0.7 units to 18.7° API and the olefin contents increased to 0.55 wt-%.

Experimental Case 2:

The oil was treated at a maximum temperature of 410° C. (mean of 401° C. in the thermal conversion temperature range (>380° C.)) and a pressure of 9900 kPa. The residence time in the thermal conversion temperature range was about 4.5 minutes. The kinematic viscosity at 15° C. of the liquid was reduced with 61% to 326 cSt, the gravity was increased with 0.9 units to 18.9° API and the olefin contents increased to 1.05 wt-%.

Experimental Case 3:

The oil was treated at a maximum temperature of 430° C. (mean of 411° C. in the thermal conversion temperature range (>380° C.)) and a pressure of 10500 kPa. The residence time in the thermal conversion temperature range was about 4.5 minutes. The kinematic viscosity at 15° C. of the liquid was reduced with 76% to 201 cSt, the gravity was increased with 1.3 units to 19.3° API and the olefin contents increased to 1.45 wt-%.

| | Process conditions | | | Initial hydrocarbon properties | | | Visbroken hydrocarbon properties | | |
|---|---|---|---|---|---|---|---|---|---|
| | Temperature | Pressure | Residence | Viscosity | Gravity | Olefin | Viscosity | Gravity | Olefin |
| | (° C.) | (kPa) | time (min) | (cSt) | (°API) | (wt-%) | (cSt) | (°API) | (wt-%) |
| Case 1 | 390 | 9500 | 4.6 | 832 | 18.0 | 0.3 | 472 | 18.7 | 0.55 |
| Case 2 | 410 | 9900 | 4.5 | | | | 326 | 18.9 | 1.05 |
| Case 3 | 430 | 10500 | 4.5 | | | | 201 | 19.3 | 1.45 |

1. A method for preparing a pipelineable hydrocarbon mixture from a crude heavy hydrocarbon mixture comprising:
visbreaking said crude heavy hydrocarbon mixture at a temperature of 350 to 440° C. and a pressure of 20 to 150 bar for 0.5 to 15 minutes to produce a visbroken hydrocarbon mixture; and
mixing said visbroken hydrocarbon mixture with a diluent to produce said pipelineable hydrocarbon mixture.

2. A method as claimed in claim 1, wherein said visbreaking is at a temperature of 390 to 415° C.

3. A method as claimed in claim 1, wherein said visbreaking is at a pressure of 50 to 150 bar.

4. A method as claimed in claim 1, wherein said visbreaking is for 1 to 10 minutes.

5. A method as claimed in claim 1, wherein said visbreaking has a conversion of 1 to 14%.

6. A method as claimed in claim 5, wherein said visbreaking has a conversion of 8 to 10%.

7. A method as claimed in claim 1, wherein substantially all of the crude heavy hydrocarbon mixture is visbroken.

8. A method as claimed in claim 1, wherein at least 90% wt of said visbroken hydrocarbon mixture is incorporated into said pipelineable hydrocarbon mixture.

9. A method as claimed in claim 1, wherein said crude heavy hydrocarbon mixture is separated from a heavy hydrocarbon and water mixture in a separator prior to said visbreaking.

10. A method as claimed in claim 9, wherein diluent is added to said heavy hydrocarbon and water mixture prior to, or during, separation in said separator.

11. A method as claimed in claim 10, wherein said crude heavy hydrocarbon mixture that undergoes visbreaking comprises 60 to 95% wt heavy hydrocarbon and 5 to 40% wt diluent.

12. A method as claimed in claim 9, wherein no additives are added to said crude heavy hydrocarbon mixture following separation from water and prior to, or during, said visbreaking.

13. A method as claimed in claim 9, further comprising extracting a heavy hydrocarbon and water mixture from a subterranean formation.

14. A method as claimed in claim 13, wherein said extracting is by SAGD.

15. A method as claimed in claim 1, wherein the API gravity of the crude heavy hydrocarbon mixture that undergoes visbreaking is 16 to 18°.

16. A method as claimed in claim 1, wherein the viscosity of the crude heavy hydrocarbon mixture that undergoes visbreaking is 500 to 1500 cSt at 15° C.

17. A method as claimed in claim 1, wherein the API gravity of said visbroken hydrocarbon mixture is 17 to 19.5°.

18. A method as claimed in claim 1, wherein the viscosity of said visbroken hydrocarbon mixture is 200 to 750 cSt at 15° C.

19. A method as claimed in claim 1, wherein said visbroken hydrocarbon mixture comprises less than 3.0% wt olefins.

20. A method as claimed in claim 9, wherein at least 90% wt of the crude heavy hydrocarbon mixture separated from the heavy hydrocarbon and water mixture is visbroken.

21. A method as claimed in claim 9, wherein 20 to 80% wt of the crude heavy hydrocarbon mixture separated from the heavy hydrocarbon and water mixture is visbroken.

22. A method as claimed in claim 1, wherein the amount of diluent added to said visbroken hydrocarbon mixture is 0.5 to 20% wt based on the total weight of said pipelineable hydrocarbon mixture.

23. A method as claimed in claim 1, further comprising mixing the visbroken hydrocarbon mixture with non-visbroken crude heavy hydrocarbon mixture.

24. A method as claimed in claim 1, wherein said pipelineable hydrocarbon mixture meets a pipeline specification.

25. A method of transporting a heavy hydrocarbon mixture recovered from a wellsite to a refinery comprising:
preparing a pipelineable hydrocarbon mixture from a crude heavy hydrocarbon mixture by a method as defined in claim 1 at said wellsite; and
pumping said pipelineable hydrocarbon mixture to said refinery.

26. A heavy hydrocarbon recovery process comprising:
extracting a heavy hydrocarbon and water mixture from a subterranean formation;
adding a diluent to said heavy hydrocarbon and water mixture;
separating a crude heavy hydrocarbon mixture from said heavy hydrocarbon and water mixture in a separator;
visbreaking said crude heavy hydrocarbon mixture as defined in claim 1 to produce a visbroken hydrocarbon mixture;
mixing said visbroken hydrocarbon mixture with a diluent and optionally non-visbroken crude heavy hydrocarbon mixture to produce a pipelineable hydrocarbon mixture; and
pumping said pipelineable hydrocarbon mixture to a refinery.

27. A system for preparing a pipelineable hydrocarbon mixture from a crude heavy hydrocarbon mixture comprising:
a separator for separating a heavy hydrocarbon and water mixture into a crude heavy hydrocarbon mixture and water, wherein said separator has an inlet for heavy hydrocarbon and water mixture, an outlet for water and an outlet for crude heavy hydrocarbon mixture;
a visbreaker for visbreaking said crude heavy hydrocarbon mixture having an inlet for crude heavy hydrocarbon mixture fluidly connected to crude heavy hydrocarbon outlet of said separator and an outlet for visbroken hydrocarbon mixture;
a cooling means for cooling said visbroken hydrocarbon mixture having an inlet for visbroken hydrocarbon mixture fluidly connected to the visbroken hydrocarbon mixture outlet of said visbreaker and an outlet for cooled visbroken hydrocarbon mixture; and
a means for adding diluent to said cooled visbroken hydrocarbon mixture to produce said pipelineable hydrocarbon mixture.

28. A system as claimed in claim 27, further comprising a means for adding diluent to said heavy hydrocarbon and water mixture either prior to, and/or in, said separator.

29. A system as claimed in claim 27, further comprising a heating means in between said separator and said visbreaker having an inlet for crude heavy hydrocarbon mixture fluidly connected to the crude heavy hydrocarbon mixture outlet of said separator and an oulet for heated crude heavy hydrocarbon mixture fluidly connected to said inlet for crude heavy hydrocarbon of said visbreaker.

30. A system as claimed in claim 27, further comprising a well arrangement for extracting said heavy hydrocarbon and water mixture from a subterranean formation, wherein said well arrangement is fluidly connected to said inlet for heavy hydrocarbon and water mixture of said separator.

31. A system as claimed in claim 27 comprising:
a well arrangement for extracting a heavy hydrocarbon and water mixture from a subterranean formation;
a means for adding diluent to said heavy hydrocarbon and water mixture either prior to, and/or in, said separator;
a separator for separating said heavy hydrocarbon and water mixture into a crude heavy hydrocarbon mixture and water, wherein said separator has an inlet for heavy hydrocarbon and water mixture fluidly connected to said well arrangement, an outlet for water and an outlet for crude heavy hydrocarbon mixture;
a heating means for heating said crude heavy hydrocarbon mixture having an inlet for crude heavy hydrocarbon mixture fluidly connected to the crude heavy hydrocarbon mixture outlet of said separator and an oulet for heated crude heavy hydrocarbon mixture;
a visbreaker for visbreaking said crude heavy hydrocarbon mixture having an inlet for crude heavy hydrocarbon mixture fluidly connected to the heated crude heavy hydrocarbon mixture outlet of said heating means and an outlet for visbroken hydrocarbon mixture;
a cooling means for cooling said visbroken hydrocarbon mixture having an inlet for visbroken hydrocarbon mixture fluidly connected to the visbroken hydrocarbon mixture outlet of said visbreaker and an outlet for cooled visbroken hydrocarbon mixture; and
a means for adding diluent to said cooled visbroken hydrocarbon mixture to produce said pipelineable hydrocarbon mixture.

32. A pipelineable hydrocarbon mixture obtainable by the method of claim 1.

33. A pipelineable hydrocarbon mixture obtained by the method of claim 9.

34. A visbroken hydrocarbon mixture obtainable by visbreaking a crude heavy hydrocarbon mixture at a temperature of 350 to 440° C. and a pressure of 20 to 150 bar for 0.5 to 15 minutes.

35. A visbroken hydrocarbon mixture obtained by visbreaking a crude heavy hydrocarbon mixture at a temperature of 350 to 440° C. and a pressure of 20 to 150 bar for 0.5 to 15 minutes.

36. A visbroken hydrocarbon mixture as claimed in claim 34, wherein said visbroken hydrocarbon mixture is prepared by visbreaking said crude heavy hydrocarbon mixture at a temperature of 350 to 440° C. and a pressure of 20 to 150 bar for 0.5 to 15 minutes to produce the visbroken hydrocarbon mixture; and mixing said visbroken hydrocarbon mixture with a diluent.

37. A visbroken hydrocarbon mixture having the following properties:
an API gravity of 12 to 22°;
a viscosity of 50 to 2000 cSt at 15° C.; and
an olefin content of less than 3.0%.
